(19) United States
(12) Patent Application Publication
(10) Pub. No.: US 2009/0007499 A1
(43) Pub. Date: Jan. 8, 2009

(54) Cavity Head Flashing

(75) Inventors: Michael Anticich, Kaiapoi (NZ); Stephen John Hotton, Kaiapoi (NZ)

Correspondence Address: JOHN ALEXANDER GALBREATH, 2516 CHESTNUT WOODS CT, REISTERSTOWN, MD, 21136, US

(73) Assignee: Flashman Flashing Systems Limited, Christchurch (NZ)

(21) Appl. No.: 12/160,423

(22) PCT Filed: Jan. 8, 2007
(86) PCT No.: PCT/NZ07/00003

§ 371 Date: Jul. 9, 2008

(30) Foreign Application Priority Data
Jan. 12, 2006 (NZ) 542982

(51) Int. Cl. E06B 7/14

(52) U.S. Cl. 52/60; 52/745.19

(57) ABSTRACT

A cavity head flashing including a back section and an angled flat section, wherein: the angled flat section is set at an obtuse angle to the substantially vertical back section; and the flashing further includes a drain section and a bracket section, wherein: the bracket section is substantially parallel to the back section, with the drain section running between them so that the back section, the drain section and the bracket section form a substantially H-shape when viewed from the end of the flashing; and wherein: the flashing when installed is fitted with an end bung at either end.

### TECHNICAL FIELD

The present invention relates to a cavity head flashing for use in buildings. The present invention can be used for any framed opening, but is particularly applicable to installation above window cavities.

### BACKGROUND

It is known to provide flashings over the tops of window cavities, in order to prevent falling water (e.g. rain) from leaking over the top of the window and into the building.

However many modern buildings have encountered problems with water becoming trapped next to structural timber framing, resulting in a deterioration in the structural integrity of the building.

Present flashings are vulnerable to allowing water to enter the flashing, particularly through the cut ends of the flashing, which are unprotected. Excess water on the top of the flashing can enter key areas, such as the cavity between the timber framing and the exterior cladding of the building.

### DISCLOSURE OF INVENTION

It is an object of the present invention to provide an improved cavity head flashing which reduces the risk of water entering the building.

The present invention consists of a cavity head flashing including a back section and an angled flat section, wherein:
the angled flat section is set at an obtuse angle to the substantially vertical back section; and
   the flashing further includes a drain section and a bracket section, wherein:
the bracket section is substantially parallel to the back section, with the drain section running between them so that the back section, the drain section and the bracket section form a substantially H-shape when viewed from the end of the flashing; and
   wherein:
the flashing when installed is fitted with an end bung at either end.

Preferably the flashing further includes a drop section which is substantially vertical and descends from the lower end of the angled flat section.

Preferably the flashing is fabricated as an extrusion suitable for cutting to the desired length on site, and is formed of a material selected from the list comprising: aluminium, plastics materials or galvanised iron. Preferably the drain section is perforated with holes.

Preferably the end bungs are manufactured from a metal, semi-rigid plastics or rubber material and are dimensioned so as to form a watertight seal between the bracket section, drain section, back section and angled flat section.

The present invention further comprises a method of installing a cavity head flashing wherein the flashing includes a back section, an angled flat section and a drop section, wherein:
the angled flat section is set at an obtuse angle to the substantially vertical back section and the drop section is substantially vertical and descends from the lower end of the angled flat section; and
   the flashing further includes a drain section and a bracket section, wherein:
   the bracket section is substantially parallel to the back section, with the drain section running between them so that the back section, the drain section and the bracket section form a substantially H-shape when viewed from the end of the flashing; and
   including the steps of:
(i) attaching the flashing to the framing of a building via the back section;
(ii) spacing standard battens at intervals along the flashing, so that the battens sit on top of the bracket section and lie flush against the back section, leaving a space between each batten and the drain section;
(iii) attaching known cladding to the battens; and
(iv) inserting end bungs into each end of the flashing.

### BRIEF DESCRIPTION OF DRAWINGS

By way of example only, a preferred embodiment of the present invention is described in detail with reference to the accompanying drawings, in which:—FIG. 1 is a perspective view of the flashing;

FIG. 2 is a cross-sectional view of the flashing in situ; and

FIG. 3 is a side view of an end bung for use in the present invention.

### BEST METHOD OF CARRYING OUT THE INVENTION

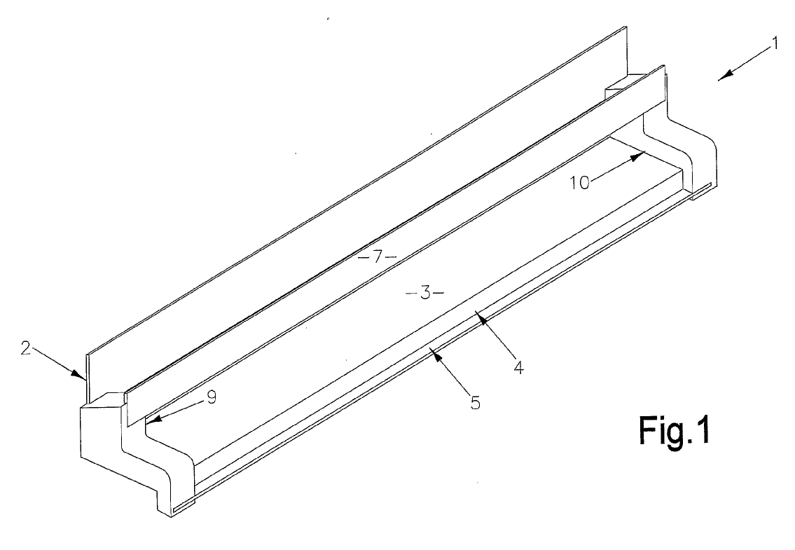

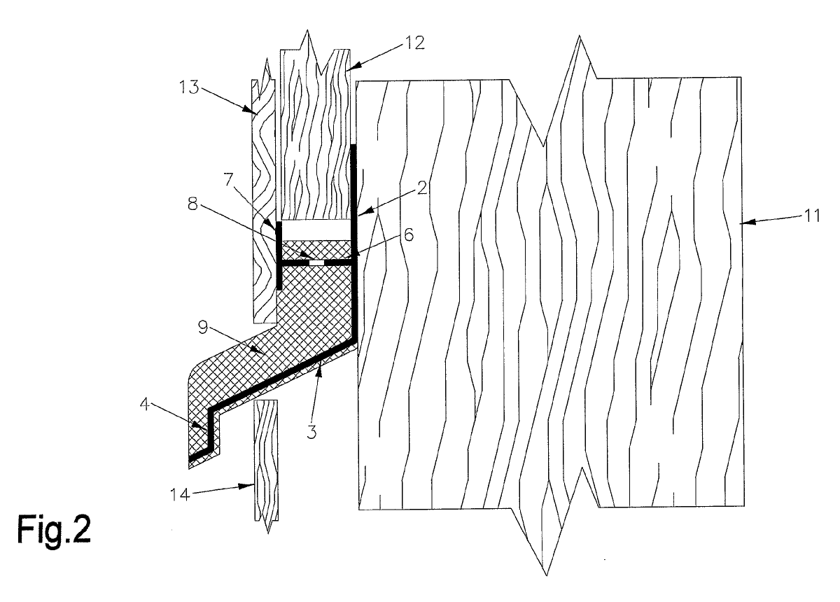

In a preferred embodiment, shown in FIGS. 1 and 2, the flashing 1 includes a back section 2, an angled flat section 3, a drop section 4 and a lip section 5.

Angled flat section 3 is set at an obtuse angle to the substantially vertical back section 2. Drop section 4 is substantially vertical and descends from the lower end of angled flat section 3. Lip section 5 descends from the lower end of drop section 4 at an obtuse angle thereto, and away from back section 2.

The flashing 1 also includes a drain section 6 and a bracket section 7. Bracket section 7 is substantially parallel to back section 2, with drain section 6 running between them. Back section 2, drain section 6 and bracket section 7 form a substantially H-shape when viewed from the end of the flashing, as can be seen in FIG. 2. The drain section 6 is perforated with holes 8.

The flashing 1 is fabricated as an extrusion suitable for cutting to the desired length on site and may be made in any suitable material, such as aluminium, plastics materials or galvanised iron.

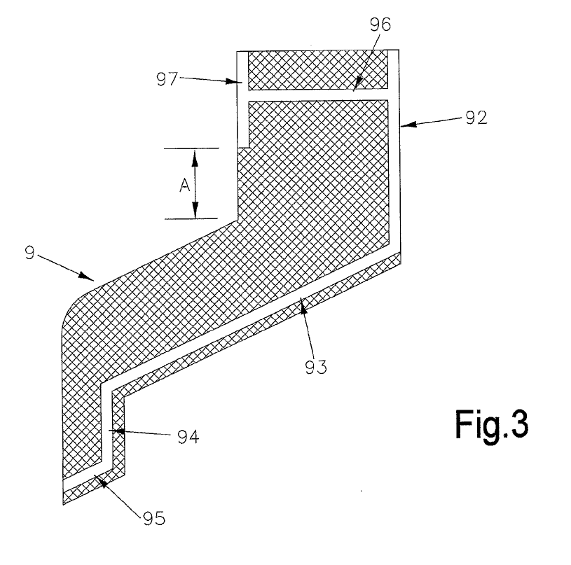

The flashing 1 is provided with end bungs 9 and 10, which are preferably manufactured from metal and coated for aesthetic appeal. End bung 10 is a mirror image of end bung 9, which is shown in side view in FIG. 3. End bung 9 is typically approximately 7 mm (seven millimetres) thick. Mating grooves 92 to 97 are provided, and are typically approximately 5 mm (five millimetres) deep. The mating grooves are dimensioned so that:
mating groove 92 fits over the end of back section 2,
mating groove 93 fits over the end of flat section 3,
mating groove 94 fits over the end of drop section 4,
mating groove 95 fits over the end of lip section 5,
mating groove 96 fits over the end of drain section 6, and
mating groove 97 fits over the end of bracket section 7.

The end bungs 9 and 10 and are dimensioned so as to form a watertight seal between the bracket section 7, drain section 6, back section 2 and angled flat section 3. Typically, the vertical distance A is 6 mm (six millimetres).

For installation, the flashing 1 is cut to the desired length for the window and is attached to framing 11 of a building via back section 2 using screws or other conventional means. Standard battens 12 are spaced at intervals along the flashing. The battens 12 sit on top of bracket section 7 and lie flush against back section 2, leaving a space between each batten 12 and drain section 6. Known cladding 13 is attached to battens 12 and the window 14 is installed in the conventional manner. End bungs 9 and 10 are inserted in each end of the flashing 1.

Any water which builds up between the cladding 13 and the framing 11 falls to the drain section 6 and through holes 8 onto the angled flat section 3, where it can run away. The top of window 14 is protected from falling water by angled flat section 3, drop section 4 and lip section 5. End bungs 9 and 10 prevent water from entering angled flat section 3 from either end of the flashing 1. Any water which hits angled flat section 3 and deflects upwards is deflected by the underside of drain section 6. Thus, the flashing 1 prevents the build-up of water against the framing 11.

1. A cavity head flashing including a back section and an angled flat section, wherein:
the angled flat section is set at an obtuse angle to the substantially vertical back section; and
the flashing further includes a drain section and a bracket section, wherein:
the bracket section is substantially parallel to the back section, with the drain section running between them so that the back section, the drain section and the bracket section form a substantially H-shape when viewed from the end of the flashing; and
wherein:
the flashing when installed is fitted with an end bung at either end.

2. A cavity head flashing as claimed in claim 1, wherein the end bungs are dimensioned so as to form a watertight seal between the bracket section, drain section, back section and angled flat section.

3. A cavity head flashing as claimed in either of claims 1 or 2, further including a drop section which is substantially vertical and descends from the lower end of the angled flat section.

4. A cavity head flashing as claimed in claim 1, wherein the drain section is perforated with holes.

5. A cavity head flashing as claimed in claim 1, wherein the flashing is formed of a material selected from the list comprising: aluminium, plastics materials or galvanised iron.

6. A cavity head flashing as claimed in claim 5, wherein the flashing is fabricated as an extrusion suitable for cutting to the desired length on site.

7. A cavity head flashing as claimed in claim 1, wherein the end bungs are manufactured from a metal, semi-rigid plastics or rubber material.

8. (canceled)

9. A method of installing a cavity head flashing wherein the flashing includes a back section and an angled flat section, wherein:
the angled flat section is set at an obtuse angle to the substantially vertical back section; and
the flashing further includes a drain section and a bracket section, wherein:
the bracket section is substantially parallel to the back section, with the drain section running between them so that the back section, the drain section and the bracket section form a substantially H-shape when viewed from the end of the flashing; and
including the steps of:
(i) attaching the flashing to the framing of a building via the back section;
(ii) spacing standard battens at intervals along the flashing, so that the battens sit on top of the bracket section and lie flush against the back section, leaving a space between each batten and the drain section;
(iii) attaching cladding to the battens; and
(iv) inserting end bungs into each end of the flashing.
